(19) United States
(12) Patent Application Publication
(10) Pub. No.: US 2023/0012120 A1
(43) Pub. Date: Jan. 12, 2023

(54) APPARATUS AND METHOD FOR SORTING AND TRADING SCRAP FOR RECYCLING

(71) Applicant: MicroRecycling Systems, Washington, DC (US)

(72) Inventor: Mario G Urdaneta, Washington, DC (US)

(73) Assignee: MicroRecycling Systems, Washington, DC (US)

(21) Appl. No.: 17/373,334

(22) Filed: Jul. 12, 2021

(51) Int. Cl. B07B 13/18; B07B 13/04; B07B 4/02

(52) U.S. Cl. CPC B07B 13/18; B07B 13/04; B07B 4/02; B07B 2220/02

(57) ABSTRACT

An apparatus and a method for separating or sorting parts and communicating information about said parts with the purpose of trading them. For example, an apparatus can include a fluidic section that comprises an input section configured to receive a plurality of parts. The fluidic section can include at least two branches extending from the input section, and each of these at least two branches can have an outlet through which the fluid or part of the fluid can be routed. The apparatus can include a set of sensors configured to capture information about the plurality of parts in the fluidic section. The apparatus can further include a set of actuators configured to effect, based on the information, a change in a movement of a set of parts from the plurality of parts such that the set of parts is distributed via the fluid to at least one of the at least two branches. The apparatus may further include electronic equipment for storing, analyzing, and communicating information about the plurality of parts. The invention is expected to support the sorting and trading of scrap and recycled materials.

### BACKGROUND

The present disclosure relates to an apparatus and to a method of use thereof for separating or sorting parts as well as communicating information about said parts with the purpose of trading the parts. The background description provided herein is for the purpose of generally presenting the context of the disclosure. The work of the presently named inventor, to the extent it is described in this background section, as well as aspects of the description that may not otherwise qualify as prior art at the time of filing, are neither expressly nor impliedly admitted as prior art against the present disclosure.

Typical machines for sorting materials in the recycling industry separate parts of materials simultaneously as the parts are exposed to the effect that underpins the separation. These typical machines may feature electromagnets and Eddy current separators (for separating according to the material's response to electromagnetic fields), electrostatic separators (for separating according to whether the material is electrically conductive or not), and shake tables (for separating according to density).

These systems and their analogues have several disadvantages. They lack precision for discriminating material properties, so they sort in a “all or nothing” basis. For example, these machines may not be capable of differentiating between different types of non-ferrous metals or between different types of insulating materials, and to compensate for this low fidelity, industry supply chains are shaped to avoid combination of materials that in the real world are often used together because they are hard to separate and poison each other during reprocessing (e.g., steel and copper). Furthermore, these typical machines have difficulty in predicting the position of a material being sorted once it is affected by the forces that discriminate the material from other materials in the plurality of materials to be recycled. As such, machines have to choose between large machine size and low separation fidelity. Another disadvantage is that typical recycling systems are configured to process a large-volume of material (typically ranging from 1 ton/hour to 50 tons/hour). As such, they are inadequately large for single sources of waste (e.g., individual factories, or individual households) and thus they are used in centralized operations to where waste from many sources is brought. Lastly, typical recycling systems may be undesirable for people to be near them because of concerns about noise, vibration, or because they are large and unsightly.

Another type of machine used in the recycling industry to sort materials operate through “sensor-based sorting” and as such rely on sensors that provide information for deciding whether a piece of material is of interest, and activate an actuator (typically jets of air, but more recently also robotic arms with suction cups) to separate that particular piece of material. A common configuration for sensor-based systems has material parts traveling on a conveyor belt that suddenly ends such that the parts become airborne and land in one of two bins. Air nozzles near the end of the conveyor belt produce puffs of air that affect the part trajectory to make it land in its intended bin. Unfortunately, the unique geometry of each part translates into slightly different forces exerted by the puff of air on each part and this puts inherent limits on the sorting fidelity of this approach, even if the material is identified accurately by the sensors.

Systems that rely on sensors use one or more types of detectors, which typically include optical detectors (ranging in light wavelength from ultra-violet to infrared), x-ray detectors for capturing x-ray fluorescence resulting from excitation by an x-ray source in the system, or x-rays that travel through the materials. Optical sensors are only able to capture information from the surface of the material and are thus prone to be confused by films covering the material (such as dirt, oil, or paint) and by fragments that have more than one material.

X-ray fluorescence sensors are very good at identifying the elements in a material, but only up to a certain depth (typically less than 1 mm) since x-ray fluorescence originating from atoms deeper in the material are absorbed by the material itself before they can leave it. Additionally, in order to identify the materials properly the system must gather enough fluorescence photons so as to generate a satisfactory material fingerprint and relatively few fluorescence photons are generated compared to the amount illuminated on the material (because of the inefficiencies of fluorescence as well as self-absorption of deeply-generated fluorescence). For example, hand-held x-ray fluorescence systems also used in the recycling industry (but not the focus of this invention) gather x-ray fluorescence for ˜1 minute before providing reliable material identification.

As a consequence, XRF-based sorting systems use very bright x-ray sources (which makes them hazardous and energy inefficient) in order to provide a strong fluorescence signal, and may also require relatively large sensing areas or move the material past the sensors slowly, such that the system has time to collect enough fluorescence x-rays.

X-ray absorbance systems have the advantage of collecting information through the entire depth of the material. However, x-ray absorbance systems used in the recycling industry focus on high-throughput of material, which means that the material being sorted can be several millimeters thick. As a consequence, such systems use high energy x-rays (i.e., 100 keV) in order for the x-rays to travel across the entire thickness of the material being sorted. High-energy x-rays require expensive sensors (e.g., scintillating crystals), heavy shielding around the sensing area, and are only able to discriminate coarsely according to atomic number because of tradeoffs in machine geometry, speed, and detection materials that have to be made to accommodate large processing capacity.

Furthermore, the attenuation of the x-rays will depend on the thickness of the material, not just the atomic composition, so an x-ray absorbance system may confuse low-Z/high-thickness with high-Z/low-thickness, thus requiring multi-sensor schemes to gain some degree of spectroscopic information.

Parts in need for separation have an enhanced appeal to their respective supply chains once separated, to the extent that the right proportions of desirable parts are present and undesirable parts absent. The uncertainty in these proportions besieges the trade of the parts. One example is in the trade of post-consumer scrap materials, because this material stream is known to vary significantly, and have lower purity and higher likelihood of hazardous materials compared to pre-consumer scrap. In trade, the recycling and scrap material industry addresses the need for information about the parts in a number of ways. One way is to determine the composition and proportion of the parts using physical and/or analytical tests of one or more samples from each batch. Tests may include x-ray fluorescence, gas chromatography-mass spectrometry, and gravimetry. This approach has a number of shortcomings. The tests are prone to artifacts and systematic errors from a number of sources, such as sampling technique, and they require special equipment and training, often taking place off-site and at additional costs. The information thus obtained is also limited to be an approximation of the whole batch inferred from a limited number of small samples from the batch. Information about the parts traded is thus inconvenient to obtain and inherently uncertain. As a result, the market often limits itself to trading batches of materials whose composition can be assessed visually. These situations hinder trade in the recycling and scrap material industry, especially among agents without performance history. It is therefore useful if agents had precise information about the parts being traded, especially for heterogeneous batches of materials whose value can be significantly different given the presence or absence of materials. And this information is best if it is received effortlessly, timely, and inexpensively.

### SUMMARY

One or more embodiments of the present disclosure relate to sorting, separating, and/or extracting specific materials from a plurality of parts (or generally, particles) and communicating information about said specific materials for its eventual sale or trade. The one or more embodiments can help mitigate or solve the above-noted issues and other issues that are readily apparent to one of ordinary skill in the art.

For example, an embodiment as featured herein can include a machine that is configured to sort small amounts of recyclable material according to elemental composition with high fidelity. By example, and without limitation, the sorting throughput may be less than about 200 kilograms per hour (kg/hr.).

According to an embodiment, there is provided an apparatus that includes a fluidic section comprising an input section. The fluidic section may be configured to receive a fluid including a plurality of parts at the input section. The fluidic section may include at least two branches extending from the input section. The apparatus may include a set of sensors configured to capture information about the plurality of parts in the fluidic section. The apparatus may include a set of actuators configured to effect, based on the information, a change in a movement of a set of parts from the plurality of parts such that the set of parts is distributed via the fluid to at least one of the at least two branches. The apparatus may further include electronic equipment for storing, analyzing, and communicating information about the plurality of parts. The ability of communicating information about the plurality of parts and/or the material extracted from it makes this invention depart from current technologies. Embodiments of this invention applied to recyclable materials communicate type, quality, and quantity of materials sorted. This has given rise to a new need for sorting equipment to communicate its findings with external customers, physically elsewhere and not connected to a local communications network. Acting as stand-alone systems, embodiments create trade connections between the material they sort and manufacturing supply chains that have a demand for the material. Large scale systems in the recycling and scrap material supply chain have no direct need to communicate with the manufacturing supply chain because they are co-located with the other machines or humans with which the machines interface; their customers are internal to an operation that includes quality assurance and sales staff. In contrast, embodiments of this invention are empowered to interface with external customers thanks to the fidelity of separation, and the information gathered in the process, that makes their output ready for sale and shipping.

### BRIEF DESCRIPTION OF THE DRAWINGS

FIG. 1 illustrates an apparatus or system according to various aspects described herein.

FIG. 2 illustrates an apparatus or system according to various aspects described herein.

FIG. 3 illustrates an assembly of apparatuses according to various aspects described herein.

FIG. 4 illustrates an assembly of apparatuses according to various aspects described herein.

FIG. 5 illustrates an assembly of apparatuses according to various aspects described herein.

FIG. 6 depicts a flow chart of a method according to various aspects described herein.

FIG. 7 illustrates a system according to various aspects described herein.

FIG. 8 depicts a marketplace with interactions between agents described herein

### DETAILED DESCRIPTION

In contrast to typical sorting technologies, the present disclosure features one or embodiments that are able to differentiate between materials of different composition and sort them with precision. Additionally, in an exemplary embodiment, because the material is to be provided to the sorting system as small particles (for example, and not by limitation, as particles having their longest dimension being less than about 20 millimeters (mm)) the different groups of sorted material originating from assemblies of mixed materials will be more homogeneous (i.e., of higher purity) than the output of typical sorting systems, which would instead operate over the entire assembly and assign its classification based on the aggregate response of all materials in the assembly.

Furthermore, because in one or more embodiments featured herein, the plurality of parts to be sorted is dispersed in a fluid, no dust is generated during sorting. Moreover, in one or more embodiments, the dimensions of the fundamental unit cell in the machine where the sorting happens, or “sorting cell”, are much smaller than what is achievable in typical sorting systems and can route parts to a greater number of different bins. Therefore, with the one or more embodiments, it is possible to build sorting systems with small capacity, and with commensurately small footprint and cost, that are practical for use in low-volume applications neglected by current (large-scale) systems.

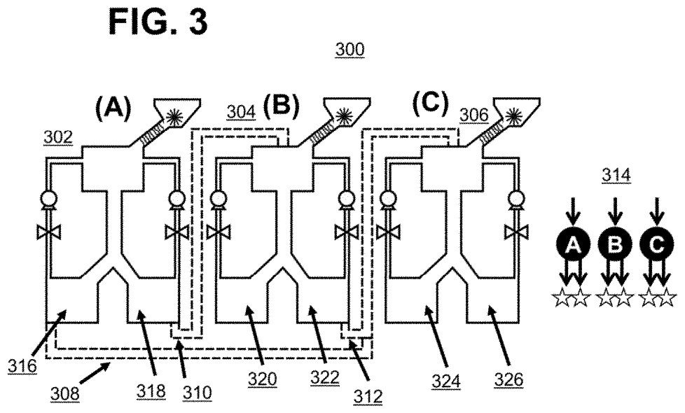

In one exemplary embodiment, a sorting system can be achieved using two or more sorting units. The two or more units can be mated, manually or automatically, using a mechanism, as shall be discussed below with respect to FIGS. 3-5. In this exemplary embodiment, the multiple sorting units forming the whole system has several advantages, when considering the sorted materials available at the output of the system. One advantage is that the homogeneity of the sorted material can be increased by connecting the multiple sorting units in series, each unit contributing in successively enhancing sorting fidelity. Another advantage is that the capacity of the sorting system can be scaled up or down by varying the number of sorting units operating in parallel. Another benefit is that the number of different materials sorted can be increased by branching out sorting units (connecting them in series and in parallel). Furthermore, the connection between multiple sorting units, from the same system or from separate systems, can be made configurable such that the system can adapt its connection topology (per user input or automatically) to change the throughput, number of sorting groups, and purity of each group, on the fly. This makes it so that a given system can be used to sort materials in ways that currently require different types of equipment and can even be later reprogrammed to sort materials in a different way.

As such, the embodiments in their structural implementations and in their associated methods of operation reflect a stark departure from legacy sorting technologies. For instance, an exemplary system as described herein can enable a degree of processing flexibility unparalleled by current systems, which rely on separate lines to separate different types of material, at much lower capital expense. Thus, exemplary systems as described herein can be small enough to capture recyclable material that typical systems, and the supply chain designed around them, currently ignore and are ill-positioned to capture and process profitably. The one or more embodiments can provide high-fidelity and high-throughput sorting for low-volume applications, which can be, for example and not by limitation, about 200 kg/hr.

Furthermore, the one or more embodiments are configured to separate products composed of several types of materials (e.g., complex products, consumer electronics). They are further configured to separate waste consisting of highly-heterogeneous waste flows, and they are configured to find rare materials from a plurality of materials, i.e., finding “needles in a haystack.” In the latter case, an example may be the high-fidelity retrieval of tantalum-bearing capacitors from discarded electronic products.

In one exemplary embodiment, the apparatus can include a small channel in which the particles to be sorted flow, one or more sensors that collect information on the composition of the particles, one or more bifurcations downstream from the sensors, actuators that control the flow in the channel and its bifurcations, and a control system that activates the actuators to control the movement of the particles based on information from the sensors such that particles of interest flow down specific channels in the bifurcation. The sensors in the channel can be of different types, such as optical (for light of wavelengths of about 300-10,000 nm), electrical (for measuring electrical impedances), magnetic (to measure the electron spin resonance frequency), or X-ray detector. A sensor as defined herein does not necessarily exclude an excitation source configured to produce a signal that interacts with the particles and then reaches a detector. For example, for an optical sensor, a light source and a detector for detecting light reflected from the particles may be part of the sensor. Several non-limiting embodiments are described further below with reference to the accompanying drawings.

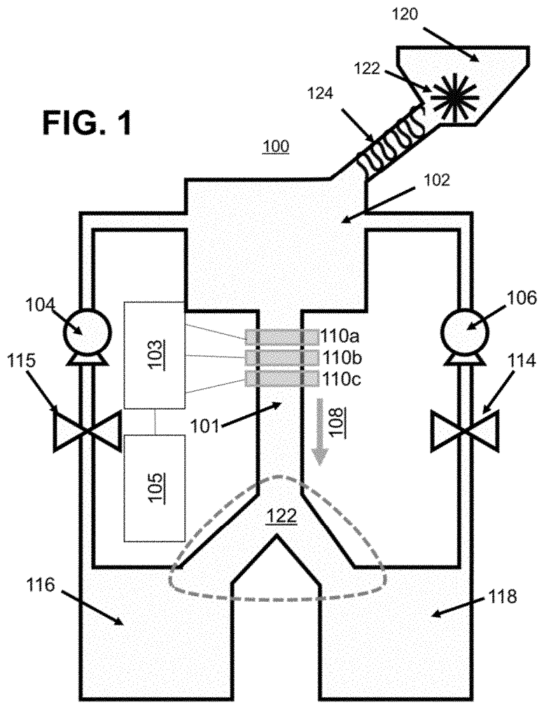

FIG. 1 illustrates a system 100 according to an embodiment. The system 100 may be filled with a fluid introduced in an input fluidic section 101. As configured, and with the fluid flowing in the input fluidic section 101, the system 100 is ready for sorting parts according to one or more modalities described below. In one use scenario, unsorted parts may be introduced into the system 100 via an inlet manifold 102. The unsorted parts may flow with the fluid in the direction 108. The unsorted parts may be made of various materials. For example, and not by limitation, the unsorted parts may be pieces of a printed circuit board that has been broken apart to make the plurality of unsorted parts. In another use scenario, assemblies of unsorted parts are introduced into the system 100 via an inlet manifold 120, reduced in size by mechanism 122, and fed into the inlet manifold 102 by a different mechanism 124. The size reduction mechanism 122 is a shredder, but it can also be without limitation a hammer mill, grinder, or other mechanism known in the scrap industry for material size reduction. The material feeding mechanism 124 is a screw conveyor, but it can also be without limitation an auger conveyor, tubeveyor, cable drag conveyor, or other mechanisms known in the scrap industry for handling parts. In both use scenarios the unsorted parts may flow with the fluid in the direction 108. In this configuration, the fluid will flow predominantly through either of the paths in the flow bifurcation at the junction 122.

As parts are introduced into the system 100 via the inlet manifold, they move with the fluid flow past a plurality of sensors (of which sensors 110a, 110b, and 110c are shown). The information collected by these sensors about each part is fed to a control system 103 that is communicatively coupled to the sensors 110a, 110b, and 110c. One of skill in the art will readily recognize that a communication link between the sensors 110a-110c and the control system 103 may be wireless, or a set of wired connections, or a combination of wired and wireless connections.

The control system 103, based on the information received from the sensors 110a-110c, may determine which of the bins 116 and 118 to route a first set of parts, the first set of parts being substantially the same (e.g., the same type of material). For example, in an exemplary use case, the control system 103 may be configured to actuate the pumps 104 and 106 as well as the valves 115 and 114, such that the first set of parts is routed to the bin 116 via a junction 122, which branches out the input fluidic section 101 in two secondary channels. Specifically, in one implementation, in order to route the first set of parts to the bin 116, the control system 103 will issue a command to actuate one or more actuators (e.g., valves 106 or 114) to cause the first set of parts flow towards the bin 116. A second set of parts may include unsorted parts or parts that are sorted according to another criterion established by the control system 103. In one implementation, the fluid will be pumped back to the inlet manifold 102 that it can be used to move other parts through the system 100. As such, the fluid is reusable. The control system 103 is connected to communications device 105 that upon command, by the user or by control system 103 according to predetermined conditions, communicates information gathered by the sensors 110a-110c and processed by the control system 103 in order to initiate the trading of the parts with other agents. One exemplary predetermined condition for control system 103 to command the communication of information, without loss of generality, is when bins 116 or 118 have reached its capacity for storing parts.

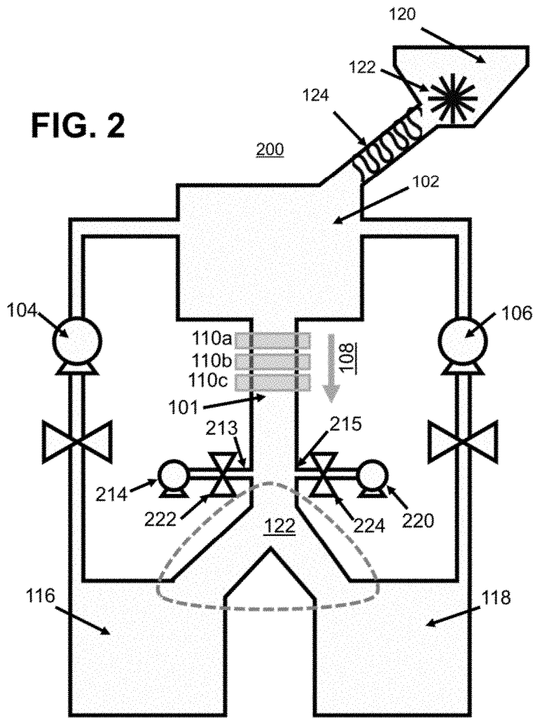

FIG. 2 illustrates a system 200 configured similarly with respect to the system 100. In the system 200, the control system 103 and the communication device 105 are not shown for ease of description. In addition to controlling the pumps 104 and 106 to establish the fluid flow in the input fluidic section 101, the control system can further control the pumps 214 and 220, or valves 222 and 224 to effect changes in the flow pattern in the input fluidic section 101 via inlets 213 and 215. For example, upon receiving information from one or all of the sensors 110a-110c, the control system 103 may cause the valve 215 to open and the valve 213 to close, which would effectively force the bulk of the flow to guide parts to the bin 116. As such, in this implementation secondary flows in a direction other than the direction 108 may be used to alter the primary flow (i.e., the flow to the input fluidic section 101) before the bifurcation at the junction 122.

FIG. 3 illustrates an assembly 300 according to an embodiment. The assembly 300 may include a plurality of systems like the systems 100 or 200. In FIG. 3, systems 302, 304, and 306 are shown for the purpose of describing the assembly 300. In other words, one of skill in the art will readily recognize that any number of systems can be arranged in the assembly 300 without departing for the scope of the present disclosure.

In the assembly 300, each one of the systems 302, 304, 308 (also denoted A, B, and C, respectively) may be equipped with a conduit 308, 310, and 312 that can connect it to a neighboring system. When such conduits are not connected (as indicated by the dashed lines), the assembly 300 simply functions as three separate systems having each a common input, and the all of the bins in each system, i.e., bins 316, 318 for system 302; bins 320 and 322 for system 304; and, 324 and 326 for system 306, are “terminal bins”, meaning bins that may hold parts at the end of the separation or sorting process. This function is illustrated in the panel 314, showing the three systems and their respective outputs. Each of the systems 302, 304, and 306 communicates information about the parts each collected in their terminal bins according to sensors in each system.

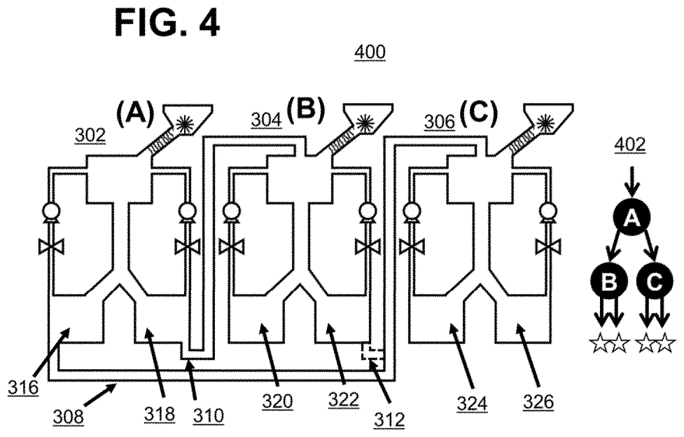

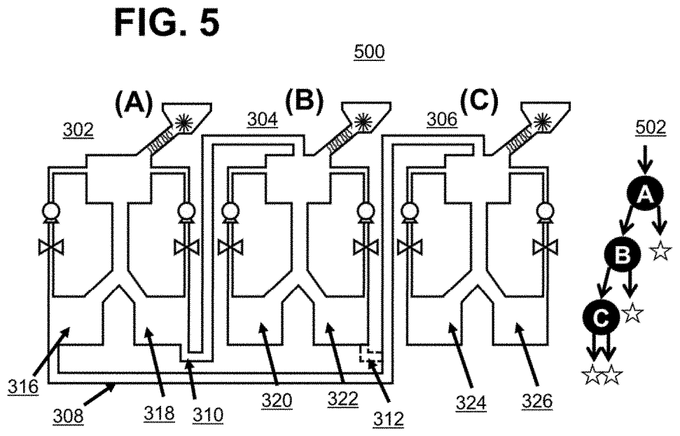

FIG. 4 illustrates an assembly 400 according to an embodiment. The assembly 400 illustrates a case where the systems 302, 304, and 306 are, unlike in FIG. 3, connected to provide an alternate function. For example, a first conduit 308 of the system 302 is connected to the system 304 and a second conduit 310 of the system 302 is connected to the system 306. This arrangement gives the assembly 400 the function illustrated in the panel 402. Specifically, the assembly 400 functions as a primary system (302) with its outputs for 316 and 318 feeding two secondary systems (304 and 306) for further processing, and which will hold the terminal bins 320 and 322 for system 304 and, 324 and 326 for system 306. Similarly, in FIG. 5, yet another arrangement is depicted in the assembly 500. In this case, as shown in the panel 502, the systems 302, 304, and 306, are arranged serially to make a cascade of systems with each output feeding to the input of the next system. In this case, the terminal bins are 316 for system 302, 320 for system 304; and 324 and 326 for system 306, are terminal bins. In each case, each of the systems 302, 304, and 306 communicates information about the parts each collected in their terminal bins according to sensors in each system.

FIGS. 3-5 illustrate yet another advantage of the exemplary systems described herein. For example, multiple instances of the systems can be tiled together to make multi-processing units, where each instance has its own particular configuration or is similarly configured to the other instances in the arrangement. One of skill in the art will readily recognize that any combinations of the arrangements 300, 400, and 500 can be made, and further, that other arrangements not described here can be made without departing from the scope of the present disclosure. Furthermore, it is noted that each system in the arrangement may be connected to the next via a mechanism that includes, but is not limited to, a flange, a connector, or a mating section or the like.

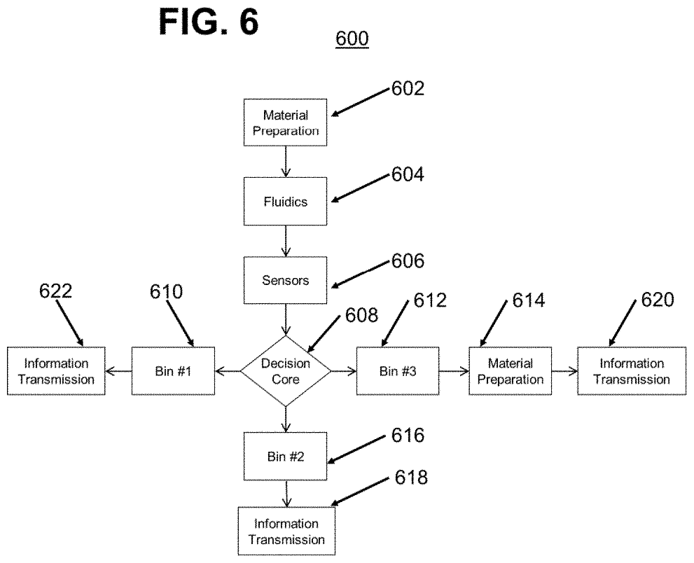

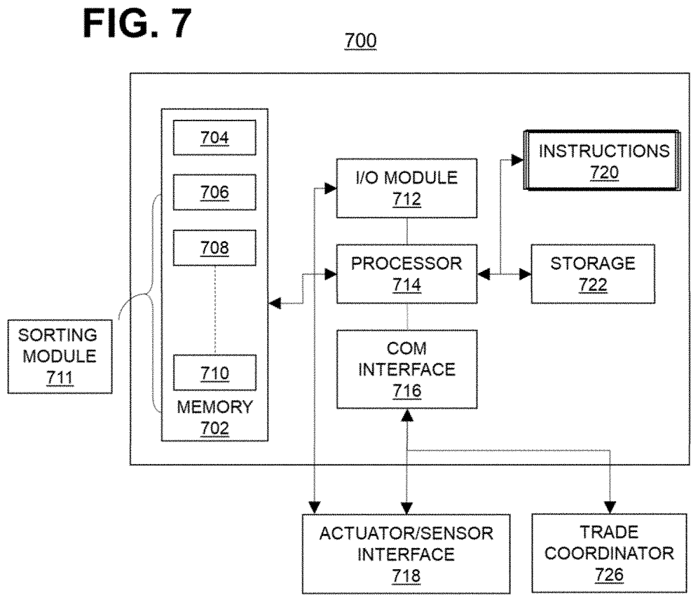

FIG. 6 illustrates a flow chart of a method 600 for utilizing the one or more of the various systems described herein. Where applicable, constitutive parts of the systems are described in the context of the method 600. The method 600 first includes preparing the material to be sorted at step 602. This may include grinding the material to make it into a plurality of smaller parts. At step 604, the method 600 includes feeding the smaller parts to the fluidic section where sensing is effectuated at step 604, as described above in regards to the one or more exemplary sensing modalities discussed. Upon routing the sensing data being received by a decision core 608, the decision core 608, which may be an application-specific computing apparatus (see FIG. 7), can instruct the actuators of the system to route a first batch of sorted parts to the bin 610 and/or a second batch of sorted parts to the bin 613 and/or a third batch of sorted parts to the bin 616. At step 614, the materials in the bin 612, for example and not by limitation, can be inputted to another like system where the method 600 may be repeated as described above. Information about the contents of each bin is transmitted in 618, 620, and 622 typically in one of three scenarios: (1) when any or all of the bins 610, 614, and 616 reach their capacity for storing parts, (2) upon a pause in the flow of incoming parts over a predetermined amount of time, taken as indication that the batch of parts has been fully processed by the system and no more parts will follow for the moment; and (3) upon command by a user.

FIG. 7 illustrates a controller 700 (or system), according to the embodiments. The controller 700 may be configured by programmable instructions to implement the decision core 608, among other functionalities associated with the method 600 and the other aspects of the systems and assemblies described in FIGS. 1-5. In the case of the assemblies 300, 400, and 500, the controller 700 can be a central unit controlling all of the systems in the assemblies or each system in the assembly can have its own controller like the controller 700, which can cooperatively function with other controllers in the assembly to achieved desired tasks.

The controller 700 can include a processor 714 having a specific structure. The specific structure can be imparted to the processor 714 by instructions stored in a memory 702 and/or by instructions 620 fetchable by the processor 714 from a storage medium 720. The storage medium 720 may be co-located with the controller 700 as shown, or it can be remote and communicatively coupled to the controller 700. Such communications can be encrypted.

The controller 700 can be a stand-alone programmable system, or a programmable module included in a larger system. For example, the controller 700 can be included in the control system 308 described previously. The controller 700 may include one or more hardware and/or software components configured to fetch, decode, execute, store, analyze, distribute, evaluate, and/or categorize information.

The processor 714 may include one or more processing devices or cores (not shown). In some embodiments, the processor 714 may be a plurality of processors, each having either one or more cores. The processor 714 can execute instructions fetched from the memory 702, i.e., from one of memory modules 704, 706, 708, or 710. Alternatively, the instructions can be fetched from the storage medium 720, or from a remote device connected to the controller 700 via a communication interface 716. Furthermore, the communication interface 716 can also interface with an actuator/sensor interface 713, i.e., with electronic hardware that control the flow rates, valves, and receive sensor data through the various parts of the above-described systems or assemblies of systems.

Without loss of generality, the storage medium 720 and/or the memory 702 can include a volatile or non-volatile, magnetic, semiconductor, tape, optical, removable, non-removable, read-only, random-access, or any type of non-transitory computer-readable computer medium. The storage medium 720 and/or the memory 702 may include programs and/or other information usable by processor 714. Furthermore, the storage medium 720 can be configured to log data processed, recorded, or collected during the operation of controller 700. The data may be time-stamped, location-stamped, cataloged, indexed, encrypted, and/or organized in a variety of ways consistent with data storage practice. By way of example, the memory modules 706 to 710 can form a sorting module 711 that includes instructions that, when executed by processor 714, cause processor 714 to perform certain operations consistent with the method 600 described above. The sorting module 711 may contain instructions that are fetched from an instruction set 718 and/or from one or more remote devices via an I/O module 712 and/or through the communication interface 716. Another use of the communications interface 716 is to communicate information collected by the sorting module and partially or completely analyzed by the processor 714 about the parts, as well as the bin designated for each of the parts by the decision core 608, to a trade coordinator 726.

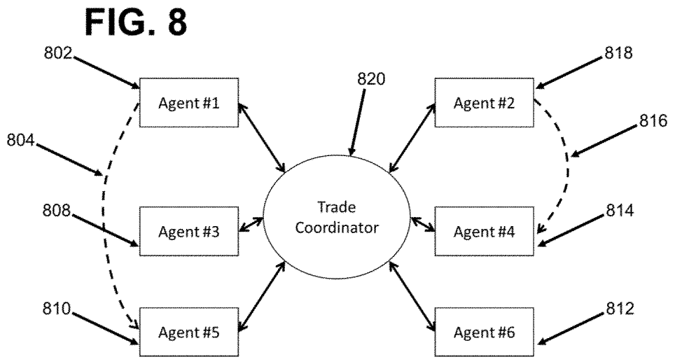

FIG. 8 depicts a marketplace with interactions between agents and mediated by a central trade coordinator 820. Agent #1, 802, and Agent #2, 818, represent the invention described herein, whereas agents 808, 810, 814, and 812 and they are typically humans but it can also be automated systems designed for placing purchasing requests. In one exemplary use case 802 received an amount of parts that have been processed and information about the parts has been communicated to the trade coordinator 820 according to the teachings in this disclosure. Trade coordinator 820 matches the parts offered by 802 with a concurrent request for similar parts by 810 and enables trade 804 between 802 and 810. In this case, the invention described in this disclosure significantly facilitates the trade by having a built-in, automated, capability to communicate with the trade coordinator 820, or agents 808, 810, 814, and 812, as desired and unmediated by 820.

Generally, an embodiment consistent with the teachings featured herein may include an apparatus, like the systems 100 or 200, whose structural configuration allows low-volume, high-throughput, and high-fidelity sorting and/or separation operations. This exemplary apparatus may include a fluidic section that comprises an input section. The fluidic section may be configured to receive a fluid including a plurality of parts at the input section. For example, and not by limitation, the fluidic section may be configured to receive the fluid at an inlet port of the fluidic section. The fluidic section may include at least two branches extending from the input section, and each of these at least two branches may have an outlet through which the fluid or part of the fluid may be routed. The apparatus may include a set of sensors configured to capture information about the plurality of parts in the fluidic section. The apparatus may further include a set of actuators configured to effect, based on the information, a change in a movement of a set of parts from the plurality of parts such that the set of parts is distributed via the fluid to at least one of the at least two branches.

In the embodiment, a specified part from the set of parts, one (or generally a subset of parts) of the set of parts can include a metal, while another part (or generally another non-overlapping subset) can include non-metallic parts. includes a metal. The embodiment may be configured to allow low-volume sorting and/or low-volume separations. For example, the apparatus may be configured with a volume of fluid, taken from an inlet of the input section to an outlet of one of the at least two branches, of less than about 10 liters. Generally, this may yield a throughput of sorted parts of less than about 200 kg/hr. When embodiments of the invention are applied to the recycling and scrap materials industry, the invention sorts parts made of materials relevant to this industry, including but not limited to polypropylene, high-density polyethylene, low-density polyethylene, aluminum, steel, copper, gold and other precious metals.

Furthermore, in the exemplary apparatus, the set of actuators can include an actuator selected that is either a valve, a pin, or a jet of secondary fluid. Generally, without limitation, the set actuators may be actuators that are all the same or they may be a set of different actuators. In the case of a jet fluid actuator, the fluidic section may include side ports through which a jet of secondary fluid may be forcibly introduced in the fluid (here the primary fluid) in order to effect a change in the trajectory of the plurality of parts. In this case, the jet of secondary of secondary fluid may be either a liquid or a gas.

The apparatus can further include a set of sensors. Without limitation, but by example only, the set of sensors may include an impedance senor, a magnetic sensor, a mechanical sensor, an acoustic sensor, or an optical sensor. One of ordinary skill in the art will readily recognize that all of the sensors in the set may be of one type or that the set of sensors may be the combination of several types of sensor; in the latter case, several sensing modalities can be used, without departing from the scope of the present disclosure.

In the case of an impedance sensor, the sensor may be configured to capture information about the complex formed by the fluid and the parts located therein based on a single operating frequency. Without limitation, but by example, this single frequency may be about 10 kilohertz (kHz). In an alternate embodiment, the impedance sensor may be configured to capture the information using a plurality of operating frequencies at simultaneously or sequentially. For example, and not by limitation, the sensor may be configured to operate at frequencies of about 100 Hz, 1 kHz, and 100 kHz. One of skill in the art will readily recognize that generally, two or more frequencies can be used, without departing from the scope of the present disclosure.

In the case of a mechanical sensor, the sensor may be configured to detect a force or displacement. In the case of an acoustic sensor, the sensor may be configured to detect amplitude and/or phase of sounds. In the case of an optical sensor, capturing the information may be based on either a reflectance, an absorbance, a transmittance, a fluorescence, a diffraction, a polarizing, or a scattering profile of the fluid and parts. In alternate embodiment, a combination of one or more or of all these modalities may be used without departing from the scope of the present disclosure. In an alternate embodiment, the optical sensor may be an X-Ray detector, and capturing the information may be based on detecting an X-Ray having an energy in the range of about 1 keV to about 100 keV. In yet another alternate embodiment, the range of the detected X-Ray may be in the range of about 2 keV to about 20 keV.

Another embodiment consistent with the teachings featured herein may be an assembly including two or more apparatuses like the one described above, where all the apparatuses in the assembly have the same configuration or where at least two apparatuses in the assembly have distinct configurations. For example, in the latter case, an embodiment may feature a first apparatus including a set of sensors based on optical detection and second apparatus including a set of sensors based on mechanical detection. Generally, one of skill in the art will readily appreciate that combinations of distinct configurations may be achieved without departing from the scope of this disclosure, whether the point(s) of distinction between configurations is based on the sensing modalities contemplated herein or on the physical specification of the fluidic section in each apparatus.

In one exemplary implementation, each apparatus of the assembly may have the same or substantially similar configurations. Each apparatus may thus include a fluidic section including an input section. The fluidic section can be configured to receive a fluid including a plurality of parts therein. The fluidic section can include at least two branches extending from the input section.

The apparatus may include a control module configured to effect a change in a movement of a set of parts from the plurality of parts such that the set of parts is distributed via the fluid to at least one of the at least two branches. In this implementation, each apparatus has its own control module. In other implementations, there may be a central control module with peripheral hardware coupled with each apparatus in the assembly, where the peripheral hardware is configured to effect the change in the movement. The control module is configured to cause a force selected from at least one of a dielectrophoretic force, an electrophoretic force, an electrodynamic force, and a magnetophoretic force to be exerted on the plurality of parts. Lastly, the assembly may have a mechanism configured to mate a first apparatus from the set of apparatuses with a second apparatus from the set of apparatuses forming the entirety of the assembly.

Another embodiment consistent with the teachings featured herein may be an apparatus that includes a fluidic section having an input section configured to receive a fluid including a plurality of parts therein. The fluidic section can include at least two branches extending from the input section. The apparatus may include or it may be communicatively coupled to a control module configured to effect a change in a movement of a set of parts from the plurality of parts such that the set of parts is distributed via the fluid to at least one of the at least two branches. The control module can be configured to cause a force resulting from at least one of a dielectrophoretic force, an electrophoretic force, an electrodynamic force, and a magnetophoretic force to be exerted on the plurality of parts.

A system based on the teachings of the instant disclosure may be implemented as a stand-alone machine that is supplied with complex, heterogeneous material, produces two or more outputs streams containing homogeneous materials, and is able to communicate information about the materials collected by its sensors. An exemplary system may be used in the recycling and the mining industries. Once processed by one such system, materials will have higher value, in terms of economic value, regulatory requirements, environmental benefits, processability by downstream systems, or in aspects other than those relating to the materials initially provided to the system as when input to the system. Very importantly, since the system is able to provide timely and accurate information about the quantity and composition of the material processed, then the material becomes much more valuable than the same material if processed by a similar system that separated the parts in a similar way but lacked the ability to communicate information about the parts sorted, including in part by lacking the ability to explicitly rule out the presence of deleterious materials.

One way in which information about each individual part is useful is by assessing the monetary value of the sorted set of parts. One way to do this, without limitation, is by creating a bottom-up model of the contents of one or more bins based on type, quality, and quantity of the parts sorted, along with external information such as pricing and availability of a buyer. Specifically, such a model adds up the monetary value of each desirable part and deducts a penalty cost for each undesirable part. This ability is particularly valuable when the parts in a batch are heterogeneous, with some parts worth more than others, or when lots are relatively small such that variations in material flow do not even out. It is also useful for explicitly demonstrating the absence of undesirable parts. In addition, information also becomes a traceable document about the parts that can be used to satisfy regulatory, marketing, or other needs. The capability of embodiments of this invention to communicate information about the parts processed directly to others is novel for sorting systems since, as mentioned before, current sorting and separation systems are not meant to be stand-alone. This capability also brings new benefits to the operator of the sorting and separation system disclosed, as well as those that engage in trading parts processed by the system, by streamlining the trading process and improving the accuracy, detail, and reliability of the information transmitted compared to human-initiated communication, for example and without limitation to oral (i.e., via phone) or written (i.e., via email, or entered into a web-based form) as is done today.

In at least some embodiments of the invention enters in communication with one or more central trade coordinators. Trade coordinator is a central trusted clearinghouse where the actual matching between offers and demands takes place, and it is not unlike established trading platforms previously disclosed in U.S. Pat. No. 8,326,754B2 and U.S. Ser. No. 10/402,905B2. Alternatively, in at least some embodiments of the invention enters in communication with one or more agents interested in trading parts.

Another setting in which information about each individual part is useful is to manage assets within an organization, akin to a manufacturing operation or a scrap yard, where multiple machinery, similar or dissimilar to this invention, are operating. In such setting, it is useful to its administrators to have up-to-date information about the activities, status, and value added of the assets in the setting for the purpose of managing operations. In this case, the information may not be used directly for (monetary) trade, but rather for the management of business assets.

Lastly, although the drawings describe operations in a specific order and/or show specific arrangements of components and are described in the context of recycling, separating particles, or extracting specific materials from a plurality of parts, one should not interpret that a specific order and/or arrangements of the components and/or steps of described methods limit the scope of the present disclosure, or that all the operations performed and the components disclosed are needed to obtain a desired result.

1. An apparatus, comprising:
a fluidic section including an input section, the fluidic section being recirculating and configured to receive at an inlet manifold a fluid including a plurality of parts therein, the fluidic section further including a plurality of primary branches extending from the input section;
wherein the fluidic section further includes a plurality of secondary branches;
a set of sensors configured to capture information about an elemental composition of the plurality of parts in the secondary branches of the fluidic section, wherein the elemental composition is indicative of an atomic composition of the plurality of parts;
a set of actuators configured to effect, based on the information, a change in a movement of a set of parts from the plurality of parts such that the set of parts is distributed via the fluid to at least one of the at least two secondary branches;
a computing unit that communicates information about the number of parts, elemental composition of such parts, and indicatives of physical dimension of such parts, to a separate one or more computers;

2. The apparatus in claim 1, wherein the apparatus communicates in real time information about the parts.

3. The apparatus in claim 1, where the parts are industrial, pre-consumer, or post-consumer products or scrap, in whole or in parts.

4. The apparatus in claim 1, where the parts are composed primarily of plastic.

5. The apparatus in claim 1, where the parts are composed primarily of metal.

6. The apparatus in claim 1, where the parts contain valuable amounts of precious metals.

7. The apparatus in claim 1, where the communication between the apparatus and other computers occurs over the internet.

8. The apparatus in claim 1, where the communication between the apparatus and other computers occurs over a private network.

9. The apparatus in claim 1, where the apparatus receives information regarding the trade of parts.

10. An apparatus comprising:
a recirculating fluidic section where parts are input and transported to other sections of the apparatus;
a sensor section where sensors collect information about the parts transported;
a bin section, where storage bins where parts are transported according to information collected by the sensors;
and a computer that transmits information about the parts transported to other computers;

11. The apparatus in claim 10, wherein the apparatus communicates in real time information about the parts.

12. The apparatus in claim 10, where the parts are industrial, pre-consumer, or post-consumer products or scrap, in whole or in parts.

13. The apparatus in claim 10, where the parts are composed primarily of plastic.

14. The apparatus in claim 10, where the parts are composed primarily of metal.

15. The apparatus in claim 10, where the parts contain valuable amounts of precious metals.

16. The apparatus in claim 10, where the communication between the apparatus and other computers occurs over the internet.

17. The apparatus in claim 10, where the communication between the apparatus and other computers occurs over a private network.

18. The apparatus in claim 10, where the apparatus receives information regarding the trade of parts.
